(19) United States
(12) Patent Application Publication
(10) Pub. No.: US 2006/0185019 A1
(43) Pub. Date: Aug. 17, 2006

(54) Method and system for observational data collection

(76) Inventor: Chun P. Wong, Los Angeles, CA (US)

Correspondence Address: Scot A. Reader, Esq., Suite 228, 1320 Pearl Street, Boulder, CO, 80302, US

(21) Appl. No.: 11/056,020

(22) Filed: Feb. 11, 2005

(51) Int. Cl. H04N 7/16

(52) U.S. Cl. 726/26

(57) ABSTRACT

A method and system for observational data collection (ODC), such as field audit and survey data collection, comprises a method, computer system and computer program for inputting into one or more configuration forms first information specifying content and format for an ODC form and one or more authorized users; and publishing at least a portion of the ODC form to one or more of the authorized users. The system and method provide an efficient and accurate alternative to ODC as compared to known approaches.

### BACKGROUND OF INVENTION

The present invention relates to methods and systems for collecting observational data. More particularly, the present invention relates to computerized methods and systems for conducting secure field audits and surveys.

Observational data are information generated from the human assessment of an object, situation or event. Collection of observational data typically involves interviewing personnel and reviewing records and credentials. Many organizations routinely conduct field audits and surveys in which they collect large volumes of observational data within their facilities for purposes of outcome analysis and regulatory compliance.

Traditionally, field audits and surveys have been conducted by hand. In such audits and surveys, auditors or surveyors typically walk through organizational departments with clipboards and paper, gathering information and entering handwritten responses to questions on preprinted audit or survey forms. This method is laborious and error-prone. The handwritten responses may be in improper form or illegible. Moreover, the handwritten responses often have to be imported into a spreadsheet for compilation and analysis, which requires additional effort and can result in transcription errors.

More recently, field audits and surveys have been conducted using custom software. In such audits and surveys, as information is gathered a designated member of an audit or survey team typically inputs responses to questions into a computer running a program specially designed for the audit or survey. While somewhat less laborious and error-prone than manual methods, only one member of the audit or survey team can typically use the computer at a time, creating a bottleneck. Also, such custom software is typically designed for a specific audit or survey, requiring an additional programming effort in order to adapt the software to a different audit or survey.

### SUMMARY OF THE INVENTION

The present invention provides an efficient and accurate method and system for observational data collection (ODC). In one aspect, the present invention provides user-friendly creation and publication of ODC forms. An exemplary method comprises inputting into one or more configuration forms first information specifying content and format for an ODC form and one or more authorized users; and publishing at least a portion of the ODC form to one or more of the authorized users, wherein the method further comprises one or more of: inputting by one or more of the authorized users into the at least portion of the ODC form, through a plurality of types of user terminals, second information in conformance with the content and format; inputting by one or more of the authorized users into the at least portion of the ODC form second information in conformance with the content and format and publishing to one or more of the authorized users in response to at least a portion of the second information at least a second portion of the ODC form; importing at least a portion of the first information from a data file created using an external software system; automatically updating a portion of the content for the ODC form to conform with data in an external database; and selecting by a form owner the authorized users from a group including at least one user dedicated to the form owner and at least one user shared by the form owner with other form owners. An exemplary system comprises a computer system for implementing one or more of the foregoing methods. Yet another exemplary system comprises a computer program having instructions executable by a processor for implementing one or more of the foregoing methods.

In another aspect, the present invention provides a form owner highly granular control over access to ODC forms. An exemplary method and system comprise inputting into one or more configuration forms information specifying form access parameters for individual authorized users of the ODC form. Form access parameters preferably specify, for each individual authorized user, what questions are viewable by that user.

In yet another aspect, the present invention provides a form owner highly granular control over access to collected observational data. An exemplary method and system comprise inputting into one or more configuration forms information specifying response access parameters for authorized users of the ODC form. Response access parameters preferably specify whether responses of others are viewable and editable by authorized users.

In yet another aspect, the present invention provides a form owner highly granular control over the format of collected observational data. An exemplary method and system comprise inputting into one or more configuration forms information specifying response format parameters for authorized users of the ODC form. Response format parameters preferably specify a valid number of responses to each question and a valid format for responses to each question.

In yet another aspect, the present invention provides a form owner highly granular control over the timing of observational data collection. An exemplary method and system comprise inputting into one or more configuration forms information specifying response time parameters for authorized users of the ODC form. Time parameters preferably specify valid times for response, valid times for editing responses and times for publishing reminders to respond.

In yet another aspect, the present invention provides efficient and accurate reporting and exporting of collected observational data. An exemplary method and system comprise, after inputting of responses into the ODC form by one or more authorized users, inputting into one or more configuration forms information specifying parameters for reporting the responses. Reporting parameters preferably specify which responses will be included, whether responses will be presented in full-text or tallied by percentages and whether responses will be exported into a data file executable by an external software application, such as a spreadsheet. The form owner can also advantageously pre-designate external systems, such as external databases, to which responses will be exported.

These and other aspects of the invention will be better understood by reference to the detailed description of the preferred embodiment taken in conjunction with the drawings briefly described below. Of course, the invention is defined by the appended claims.

### BRIEF DESCRIPTION OF THE DRAWINGS

FIG. 1A shows a network in which a method and system for observational data collection is operative in a preferred embodiment.

FIG. 1B describes an observational data collection session in a preferred embodiment.

FIG. 2 shows contents from a form management screen presented to a form owner in a preferred embodiment.

FIG. 3A shows contents from a user management screen in a preferred embodiment.

FIG. 3B shows contents from a user editing screen in a preferred embodiment.

FIG. 4A shows contents from a form source selection screen in a preferred embodiment.

FIG. 4B shows contents from a form editing screen in a preferred embodiment.

FIG. 4C shows contents from a form editing screen in another preferred embodiment.

FIG. 5A shows contents from a form level access selection screen in a preferred embodiment.

FIG. 5B shows contents from a question level access selection screen in a preferred embodiment.

FIG. 5C shows contents from a form editing screen in another preferred embodiment.

FIG. 6A shows contents from a form management screen presented to a user in a preferred embodiment.

FIGS. 6B and 6C show contents from a response entry screen in a preferred embodiment.

FIG. 7A shows contents from an updated form management screen presented to a user in a preferred embodiment.

FIGS. 7B and 7C show contents from a response selection screen in a preferred embodiment.

FIG. 7D shows contents from a response viewing screen in a preferred embodiment.

FIG. 8 shows contents from a report selection screen in a preferred embodiment.

FIG. 9A shows contents from a multiple choice management screen in a preferred embodiment.

FIG. 9B shows contents from a multiple choice source selection screen in a preferred embodiment.

FIG. 9C shows contents from a manual multiple choice editing screen in a preferred embodiment.

FIG. 9D shows a data file directory in a preferred embodiment.

FIG. 9E shows a data file table in a preferred embodiment.

FIGS. 9F and 9G show contents from dynamic multiple choice entry screens in a preferred embodiment.

FIG. 9H shows contents of a dynamic multiple choice editing screen in a preferred embodiment.

### DETAILED DESCRIPTION OF THE PREFERRED EMBODIMENT

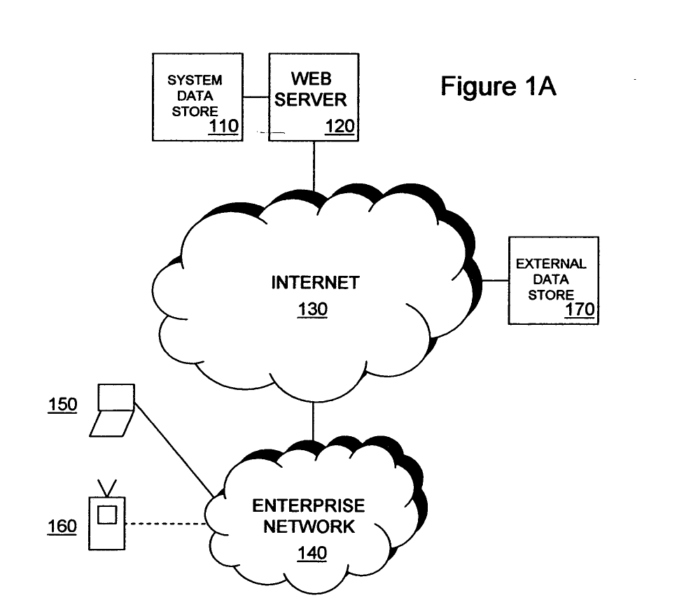

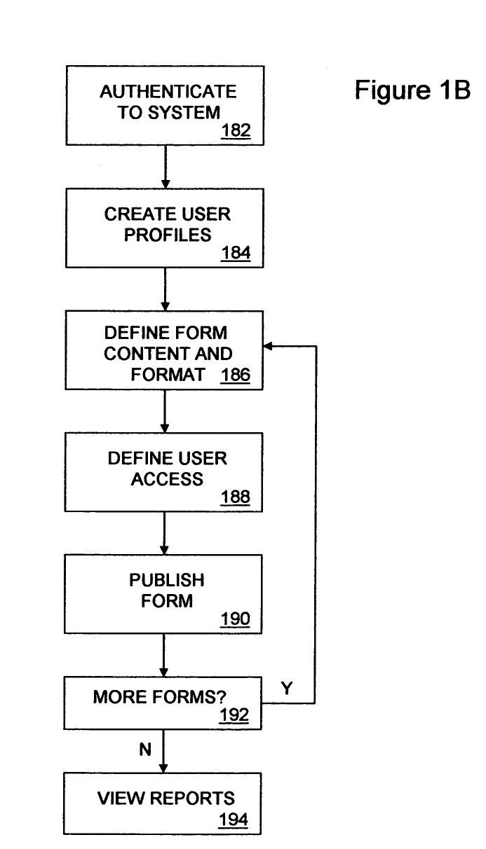

FIG. 1 shows a data communication network in which a method and system for observational data collection (ODC), such as audit or survey data collection, is operative in a preferred embodiment. The data communication network includes user terminals 150, 160 that communicate with Web server 120 via enterprise network 140 and the Internet 130. Web server 120 has one or more microprocessors that execute instructions from ODC system software hosted on Web server 120. User terminals 150, 160 have one or more microprocessors that execute instructions from Web browser software, such as Microsoft Internet Explorer, hosted on user terminals 150, 160 to access the ODC system software. Select user terminals may also have terminal extension software operative thereon to facilitate ODC. User terminals 150, 160 and Web server 120 communicate using the HTTP or HTTPS protocol over IP, ATM, MPLS, or other network protocol. The Internet 130 and enterprise network 140 may include any number of intermediate network nodes between user terminals 150, 160 and Web server 120.

User terminals 150, 160 can alternatively be configured to communicate with multiple instances of ODC system software resident within enterprise network 140 and the Internet 130. Moreover, user terminals 150, 160 may be configured to communicate solely with ODC system software resident within enterprise network 140, which in turn is configured to share data with another instance of ODC system software in the Internet 130. In general, multiple instances of ODC system software can be configured in a cooperative environment to share forms and responses transparent in a manner transparent to user terminals 150, 160.

FIG. 1 also shows system data store 110 and external data store 170. System data store 110 is a relational database that serves as a repository for ODC system data, including metadata and ODC form and response data. Web server 120 accesses system data store 110 to read and write ODC system data. Web server 120 causes select ODC system data to be replicated to external data store 170.

User terminals 150, 160 may be any of various types of end systems having user interfaces, such as desktop PCs, mobile PCs, smart phones, PDA phones and PDAs. User terminals 150, 160 may have connectivity to enterprise network 140 via a LAN connection, which may be a wired or wireless Ethernet connection. PDA-type terminals may have extension software for translating ODC forms into a viewable format and may also have handwriting or voice recognition software to facilitate ODC. Although two user terminals 150, 160 are shown, the system can support any number of user terminals.

FIG. 1B is a flow diagram illustrating an ODC session in a preferred embodiment. In the ODC session, a form owner creates and publishes one or more ODC forms, such as audit or survey forms, to one or more authorized users who respond to the ODC forms. The form owner creates and publishes forms by accessing one or more configuration forms generated by the ODC system software hosted, for example, on Web server 120. The form owner may access the configuration forms from a terminal co-located with user terminals 150, 160 in enterprise network 140, or from a terminal remote from enterprise network 140 that has Web browser software and Internet connectivity.

After authenticating to the ODC system (182) using credentials administered by an ODC system administrator, the form owner creates profiles for users (184). This step includes inputting on a user configuration form presented by the ODC system user identification and authentication information and user privileges. User privileges may include, for example, an individual user's right to change her own profile and to use a PDA-type terminal. Next, the form owner specifies the content and format of an ODC form (186). This step includes inputting on a configuration form presented by the system, for example, a source of questions, question content, question format, valid responses, valid response times and valid response editing times. Next, the form owner specifies user access to the ODC form (188). This step includes inputting on a configuration form presented by the system, for example, a specification of users who will have access to the ODC form, a specification of which individual users will have access to particular questions of the ODC form, a specification of whether users are allowed to view each other's responses and a specification of whether users are allowed to edit each other's responses. Next, the form owner publishes the ODC form (190). This step includes inputting on a form presented by the system a manifestation of a decision to submit the ODC form for publication.

After publishing an ODC form, the form owner may, in the form owner's discretion, repeat steps 186 through 190 to create and publish to selected users within the group for which the owner has created profiles additional ODC forms having different content, format, access and time parameters (192). Naturally, the form owner may return to step 184 and add, edit or delete users as well.

After the form owner, in the form owner's discretion, has finished creating and publishing ODC forms, the form owner may generate reports based on any responses input into published ODC forms by users (194). This step includes inputting on a report configuration form presented by the system a specification of, for example, what responses the report should include, whether the report should include full-text responses or a tally of responses and whether the report should be presented within the system or exported into a data file executable by a third party software application, such as a spreadsheet. The form owner may also pre-designate secondary systems, such as external data store 170, to which responses are automatically exported.

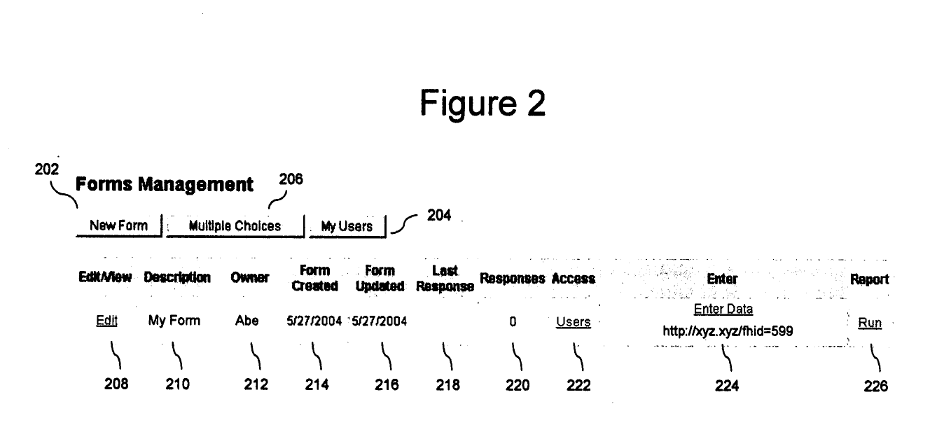

Turning to FIG. 2, contents from a form management screen presented to a form owner in a preferred embodiment are shown. These contents are displayed to the form owner after successful authentication. The contents list the form owner's current ODC forms and several selectable options. The form owner may start the process of creating a new ODC form by depressing “New Form” button 202. The form owner may start the process of creating or editing multiple choice questions for the owner's ODC forms by depressing “Multiple Choices” button 206. The form owner may start the process of creating or editing profiles of users who have access to the owner's ODC forms by depressing “My Users” button 204.

Moreover, the form owner may manage the owner's current ODC forms. For each current ODC form, the contents include a series of descriptive fields, some of which have selectable links. The descriptive fields include an Edit/View field 208 having a selectable “Edit” link allowing the form owner to start the process of editing the ODC form; a Description field 210 displaying the title of the ODC form; an Owner field 212 identifying the owner of the ODC form; a Form Created field 214 identifying the form creation date; a Form Updated field 216 identifying the date the form was last updated; a Last Response field 218 identifying the date of the most recent response; a Responses field 220 identifying the number of responses; an Access field 222 having a selectable “Users” link allowing the form owner to start the process of editing user access to the ODC form; an Enter field 224 having a selectable “Enter Data” link allowing the form owner to start the process of entering a response into the ODC form; and a Report field 226 having a selectable “Run” link allowing the form owner to start the process of generating a report based on submitted responses.

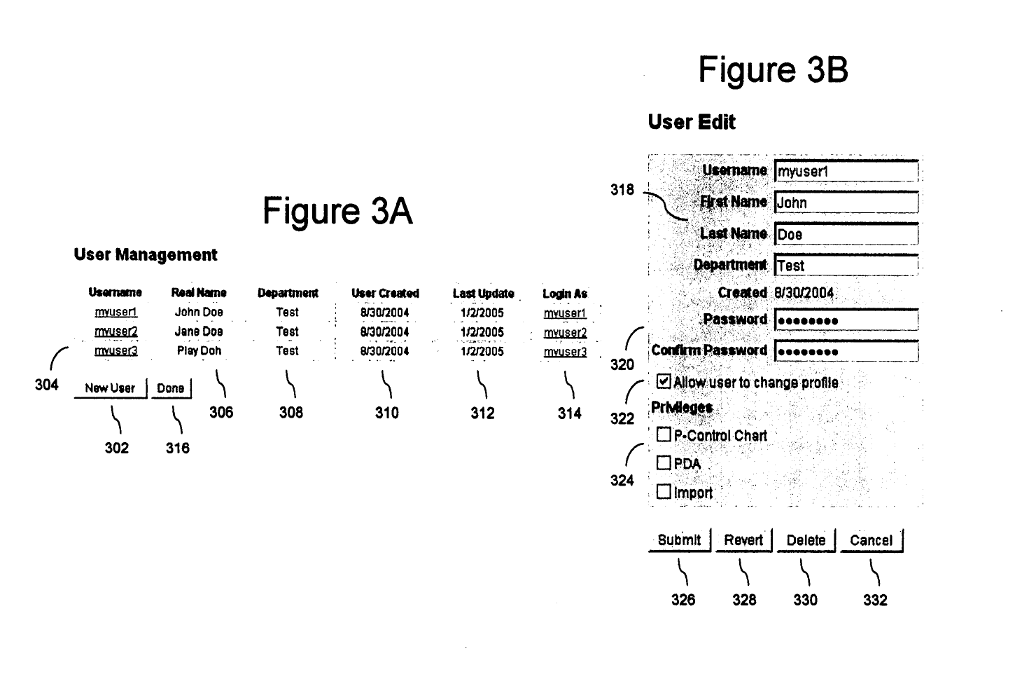

Turning to FIG. 3A, contents from a user management screen presented to a form owner in a preferred embodiment are shown. These contents are displayed to the form owner after depressing “My User” button 204. The contents include a display of the form owner's current users and several selectable options. The form owner's current users may include users created by the form owner who are dedicated to the form owner and users created by a system administrator who are shared by the form owner with other form owners. The form owner may start the process of creating a new dedicated user by depressing “New User” button 302. For each current user, the contents include a series of descriptive fields, some of which have selectable links. The descriptive fields include Username field 304, having a selectable link allowing the form owner to start the process of editing the user; Real Name field 306 identifying the user's real name; Department field 308 identifying the user's department; User Created field 310 identifying the date the user profile creation date; Last Update field 312 identifying the date the user profile was last updated; and Login As field 314 having a selectable link allowing the form owner to immediately login as that user. After the form owner has finished managing users, the form owner depresses the “Done” button 316, which returns the form owner to the form management screen. The user management screen may include additional features, such as user tracking/audit trail features that allow the form owner to display the date and time of a users last login and logout and the host name and IP address of an end system where the user is currently logged-in or last logged-in.

Turning to FIG. 3B, contents from a user editing screen presented to a form owner in a preferred embodiment are shown. These contents are displayed to the form owner after activating the link in Username field 304. In the example shown, activation of the “myuser1” link in Username field 314 caused these contents to be displayed. The contents include a display, as a series of editable entities, of the profile of the user whose link was activated. The editable entities include user identification text boxes 318, which include the user's username, first name, last name and department; credential text boxes 320, which include the user's password and confirmed password; profile edit privilege checkbox 322 indicating whether the user has the right to edit his own profile; and other privileges checkboxes 324, indicating whether the user has the right to use P-control charts (a statistical analysis report), the right to enter responses to form questions on a PDA-type terminal and the right to import responses to form questions from an external source. The right to import responses should be carefully regulated because a user can load an unlimited volume of responses. The form owner may edit the user's profile by changing the contents of the editable entities. After the form owner has finished editing the user's profile, the form owner depresses the “Submit” button to 326 to implement the edits. If the form owner wishes to revert to the user's previous profile, the form owner may depress the “Revert” button 328. If the form owner wishes to delete the user's profile, the form owner may depress the “Delete” button 330. Finally, if the form owner wishes to leave the user editing screen without implementing any edits, the form owner may depress the “Cancel” button 332. Depression of “Submit” button 326 or “Cancel” button 332 returns the form owner to the user management screen.

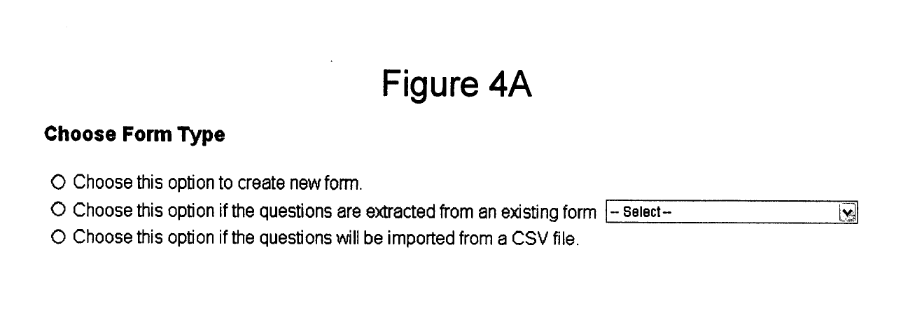

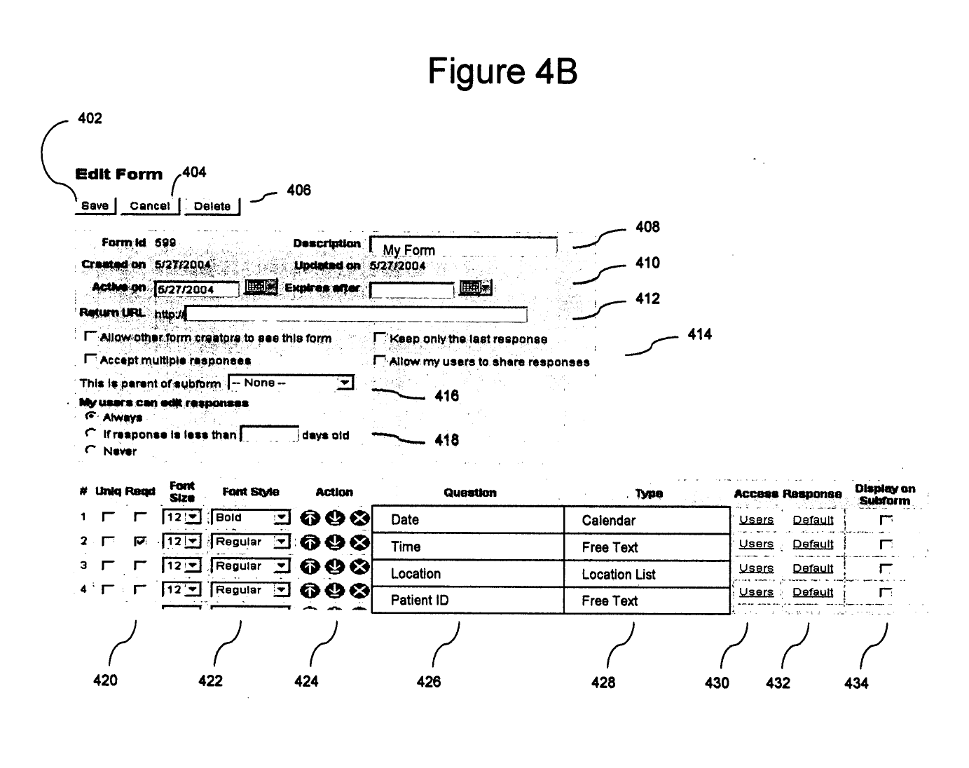

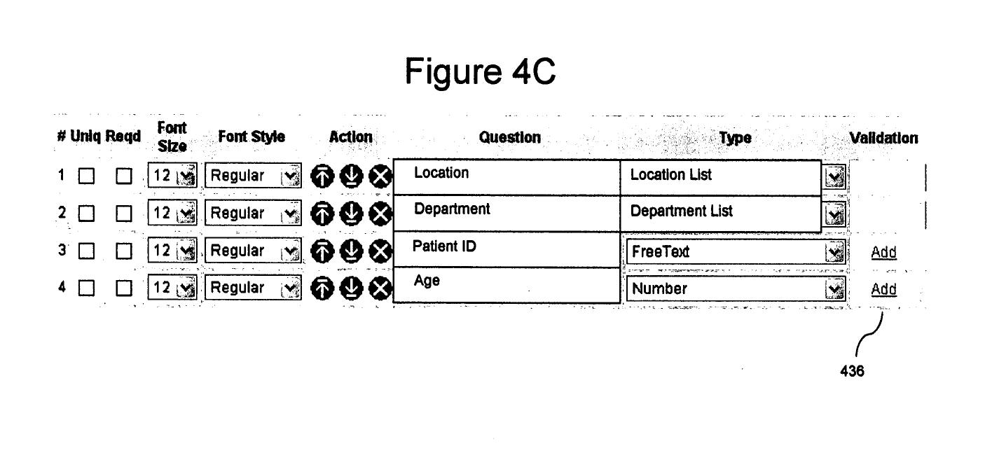

Turning to FIG. 4A, contents from a form source selection screen presented to a form owner in a preferred embodiment are shown. This screen is displayed to the form owner after depressing “New Form” button 202 on form management screen. Form source selection screen displays a multiple choice to the form owner regarding the source of questions for a new ODC form. The form owner selects the top radio button if the questions are to be input manually by the form owner. The form owner selects the middle radio button if the questions are to be a subset of questions in a current ODC form which serves as the master form. In that event, the form owner must also identify the current ODC form from a pull-down menu. The form owner selects the bottom radio button if the questions are to be imported from an external data source, such as a CSV file. The latter option allows form owners to design and edit form questions using familiar tools such as Microsoft Excel. After refining the questions in those tools, the form owner can import the questions into the ODC software system without retyping the questions.

Turning to FIG. 4B, a form editing screen presented to a form owner in a preferred embodiment is shown. This screen is displayed to the form owner after activating the “Edit” link in Edit/View field 208 on form management screen for a current ODC form, or successfully concludes the requisite steps to identify a new ODC form. In the example shown, activation of the “Edit” link in Edit/View field 208 caused the screen to be displayed.

The form editing screen displays, as a series of editable entities, the profile of an ODC form whose “Edit” link was activated. The editable entities include Description field 408, which displays the title of the ODC form. The editable entities also include “Active on” and “Expires after” fields 410, which display the publication and expiration date, respectively, of the ODC form. Users are denied access the form before the date in the “Active on” field and after the date in the “Expires after” field. The editable entities also include Return URL field 412, which displays the URL to which the user is transferred after the user submits a response to the ODC form. The return URL may, for example, provide an acknowledgement of receipt of the response or a notice thanking the user. The editable entities also include response control checkboxes 41 4. Response control checkboxes 414 include a checkbox indicating whether other form owners have a right to view the form, a checkbox indicating whether only a user's last response should be kept, a checkbox indicating whether a user may input multiple response and a checkbox indicating whether users are allowed to share responses. Alternatively, radio buttons may be presented indicating three levels in which responses can be shared among users: public, limited or private. Forms designated “public” contain responses that can be viewed and edited by any user assigned to the form. Forms designated “limited” contain responses that can be viewed by all users assigned to the form, but edited only by the user who created the response. Forms designated “private” contain responses that can be viewed and edited only by the user who created the response. The editable entities also include a subform pull-down menu 416 indicating subforms for which the ODC form is a parent. A subform is related to a parent form in a many-to-one relationship. Finally, the editable entities include a multiple choice response edit question 418. The form owner selects the top radio button if the users are always allowed to edit their responses while the ODC form is active. The form owner selects the middle radio button if users are allowed to edit their response for a limited time period after responding. In that event, the form owner must also specify the time period for editing. The form owner selects the bottom radio button if users are prohibited from editing their responses.

Additionally, for each existing question, the form editing screen includes a series of descriptive fields, some of which have editable fields and others which have selectable links, as well as action buttons. The descriptive fields include a Reqd checkbox 420 indicating whether a response to the question is mandatory; font fields 422 indicating the font size and style in which the question is displayed; and action buttons 424. Action buttons 424 include an up arrow button which, if depressed, will cause a new question to be inserted immediately above the current question, a down arrow button which, if depressed, will cause a new question to be inserted immediately below the current question, and an “X” button which, if depressed, will cause the current question to be deleted. The descriptive fields also include a Question field 426 which includes the text of the question; a Type field 428 which indicates the format of responses that appears after the question text; an Access field 430 having a selectable “Users” link allowing the form owner to manage user access to the question; a Response field 432 having a selectable “Default” link allowing the form owner to specify a default response to the question; and a Display on Subform field having a checkbox 434 indicating whether this question should be displayed on subforms of this form.

Turning momentarily to FIG. 4C, contents of a form editing screen presented to a form owner in another preferred embodiment are shown. As with FIG. 4B, these contents include series of descriptive fields, some of which have editable fields and others which have selectable links, as well as action buttons. However, in FIG. 4C, questions where the Type field indicates “FreeText” or “Number” are displayed with a Validation field 436 that has a selectable “Add” link allowing the form owner to specify a valid response format for free text or numerical responses, such as a number of alpha-numeric characters in the response or acceptable values for the response, and a hint to the user about valid responses.

Returning to FIG. 4B, the form owner may edit the form profile by changing the contents of the editable entities. After the form owner has finished editing the form profile, the form owner depresses the “Save” button 402 to implement the edits. If the form owner wishes to delete the form, the form owner may depress the “Delete” button 406. Finally, if the form owner wishes to leave the form editing screen without implementing any edits, the form owner may depress the “Cancel” button 404. Depression of “Save” button 402 or “Cancel” button 404 returns the form owner to the user management screen.

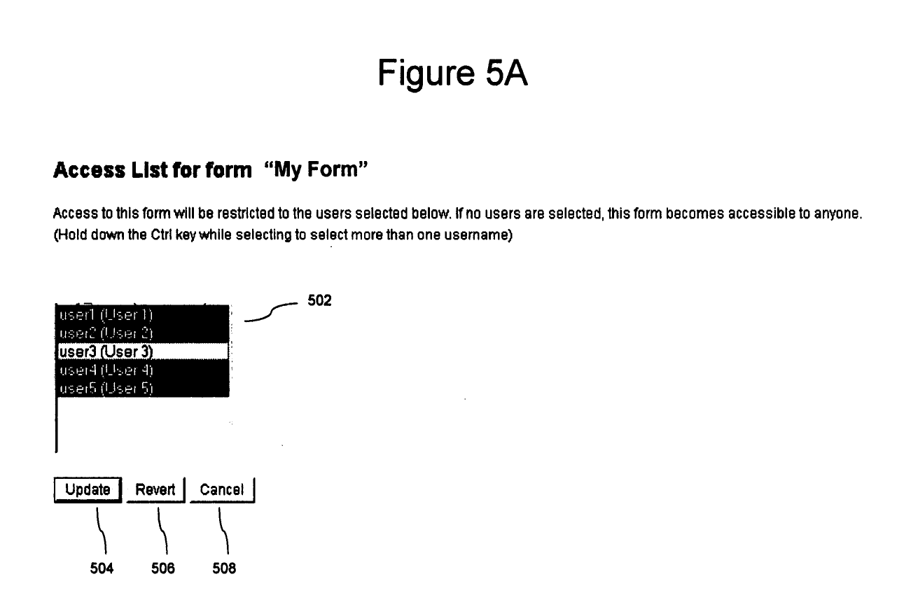

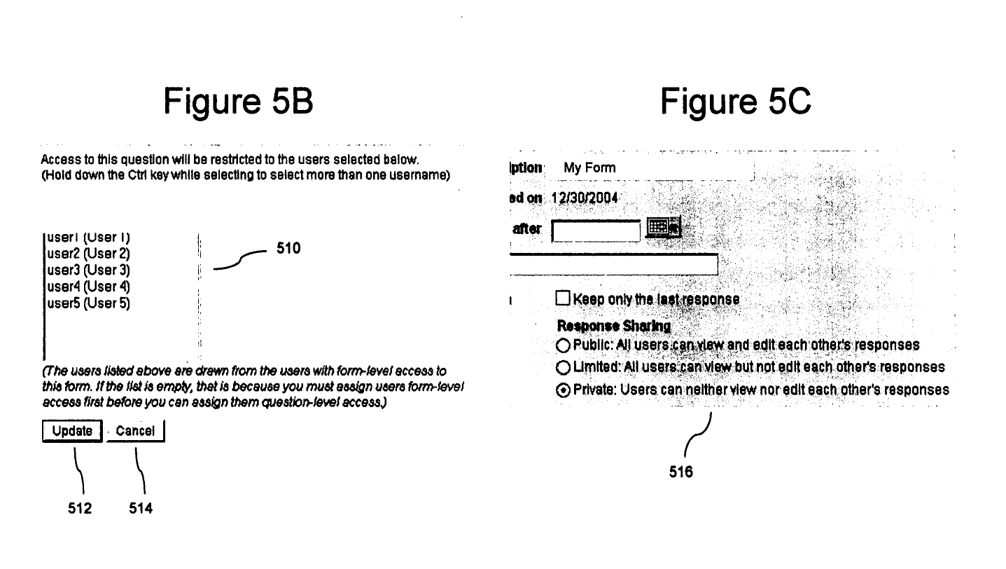

Turning to FIG. 5A, contents from a form level access selection screen presented to a form owner in a preferred embodiment are shown. These contents are displayed to the form owner after activating the “Users” link for an ODC form in access field 222 on the form management screen. The contents display all of the form owner's users, with users who currently have access to the form highlighted. The form owner can use mouse clicks to highlight and un-highight users displayed in the window and thereby authorize or prohibit their access to the form. After the form owner has finished modifying access to the form, the form owner depresses the “Update” button to 504 to implement the modifications. If the form owner wishes to revert to previous access to the form, the form owner may depress the “Revert” button 506. Finally, if the form owner wishes to leave the screen without implementing any modifications, the form owner may depress the “Cancel” button 508. Depression of “Update” button 504 or “Cancel” button 508 returns the form owner to the form management screen.

Turning to FIG. 5B, contents from a question level access selection screen presented to a form owner in a preferred embodiment are shown. These contents are displayed to the form owner after activating the “Users” link for a question in access field 430 on the form editing screen. The contents display all of the form owner's users who currently have access to the question, with users who currently have access to the question displayed in highlight. The form owner can use mouse clicks to highlight and un-highlight users and thereby authorize or prohibit their access to the question. After the form owner has finished modifying access to the question, the form owner depresses the “Update” button to 512 to implement the modifications. If the form owner wishes to leave the screen without implementing any modifications, the form owner may depress the “Cancel” button 514. Depression of “Update” button 512 or “Cancel” button 51 4 closes the window and returns the form owner to the form editing screen.

Turning to FIG. 5C, contents from a form editing screen presented to a form owner in another preferred embodiment are shown. The contents include a multiple choice question regarding response sharing 516. The form owner selects the top radio button, labeled “Public,” if users are allowed to view and edit the responses of others. The form owner selects the middle radio button, labeled “Limited,” if users are allowed to view but not edit the responses of others. The form owner selects the bottom radio button, labeled “Private,” if users are prohibited from viewing or editing the responses of others.

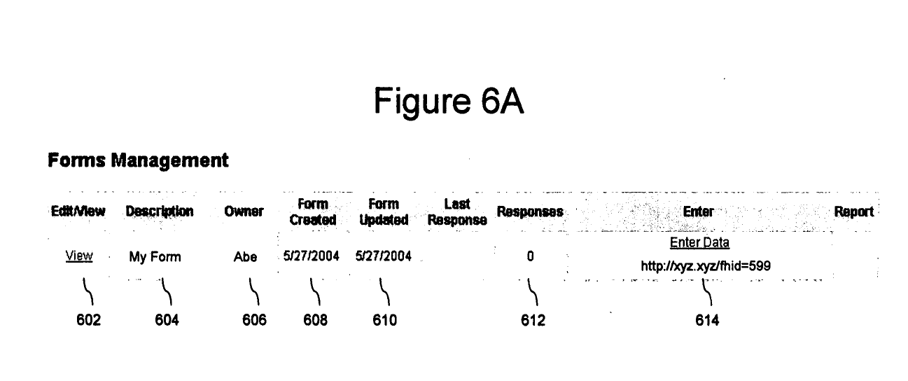

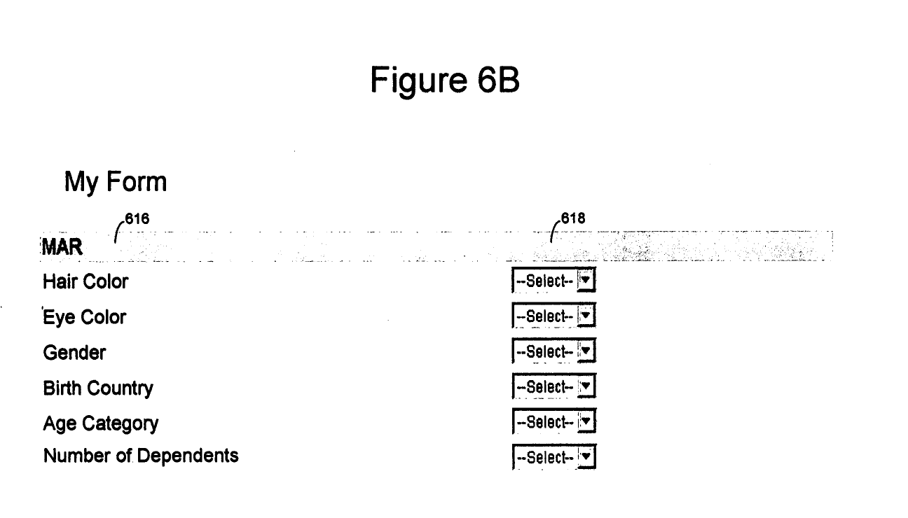

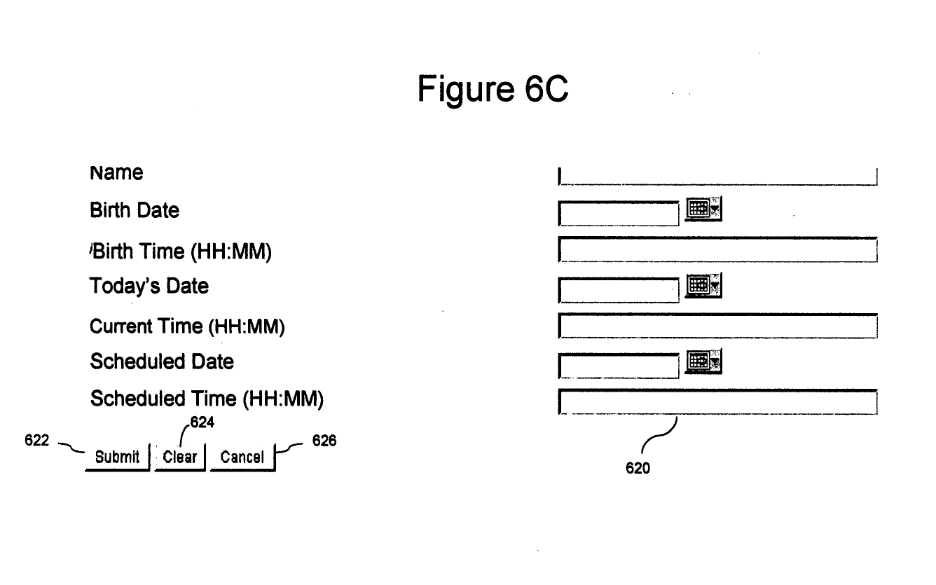

Turning to FIG. 6A, contents from a form management screen presented to a user in a preferred embodiment are shown. These contents are displayed to the user after successful authentication. The form management screen displays the current ODC forms for which the user is authorized and several selectable options. For each current form, the screen includes a series of descriptive fields, some of which have selectable links. The descriptive fields include an Edit/View field 602 having a selectable “View” link allowing the user to view the ODC form; a Description field 604 displaying the title of the ODC form; an Owner field 606 identifying the owner of the ODC form; a Form Created field 608 identifying the form creation date; a Form Updated field 610 identifying the date the form was lost updated; a Responses field 612 identifying the number of responses; and an Enter field 614 having a selectable “Enter Data” link allowing the user to start the process of entering a response into the form.

If no users are currently assigned to a form, the form is deemed to be in survey mode and does not require user authentication to enter a response. For forms in survey mode, the URL under the “Enter Data” link shown in FIG. 6A can be copied and pasted into the body of a mass email. When the email recipient clicks on the URL, the recipient is taken directly to the form for data entry. Responses entered into survey mode forms are intended to be unidirectional, meaning that once entered, they can not be edited. The responder does not have a user login or password to enter the ODC system; the responder can only enter data into the form via the given URL.

Turning to FIGS. 6B and 6C, contents from a response entry screen presented to a user in a preferred embodiment are shown. These contents are displayed to the user after activating the “Enter Data” link in Enter field 614 on form management screen. The response entry screen displays in a series of descriptive fields the ODC form whose “Enter Data” link was activated. The descriptive fields include questions fields 616, which include the ODC form questions and editable response fields 618, 620, which include editable responses to ODC form questions. In the example shown in FIG. 6B, the responses are selectable from a pull-down menu without default selections, and no responses have yet been entered. In the example shown in FIG. 6C, some responses are free text and others are selectable from a calendar menu without default selections, and no responses have yet been entered. The user may enter responses to the questions by changing the contents of editable response fields 618, 620. After the user has finished entering responses, the user depresses the “Submit” button to 622 to submit the responses. If the user wishes to delete the responses, the user may depress the “Clear” button 624. Finally, if the user wishes to leave the response entry screen without submitting any new responses, the user may depress the “Cancel” button 626. Depression of “Submit” button 622 or “Cancel” button 626 returns the user to the form management screen.

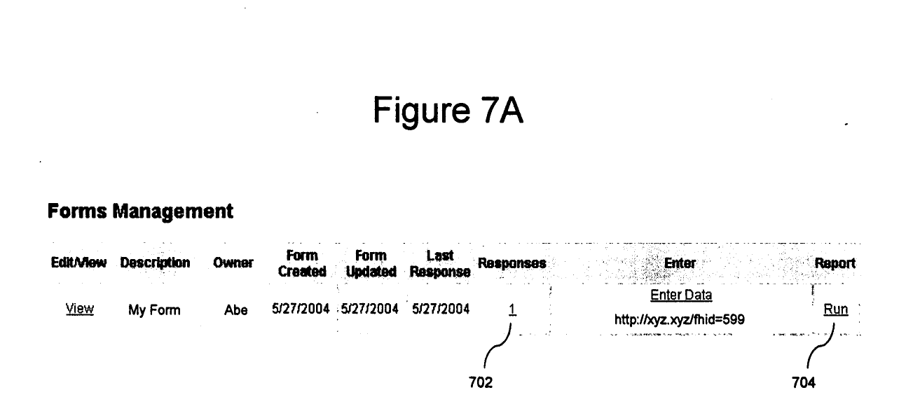

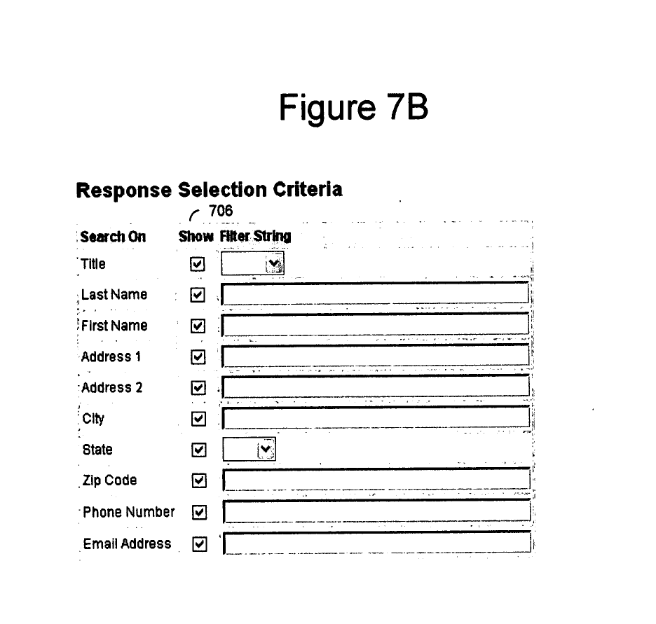

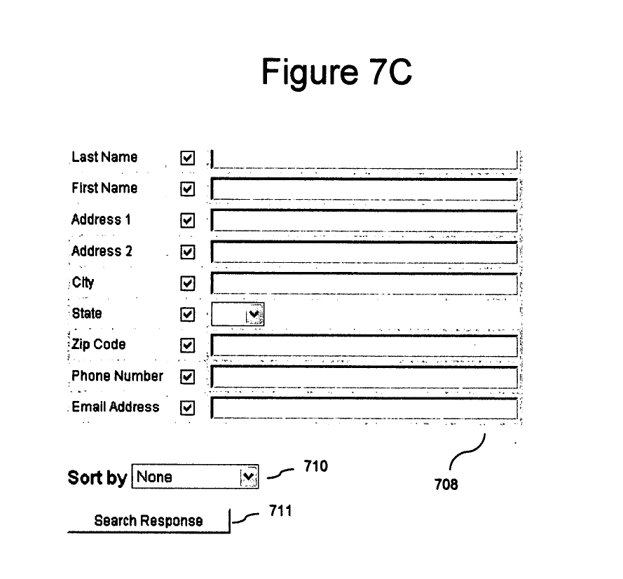

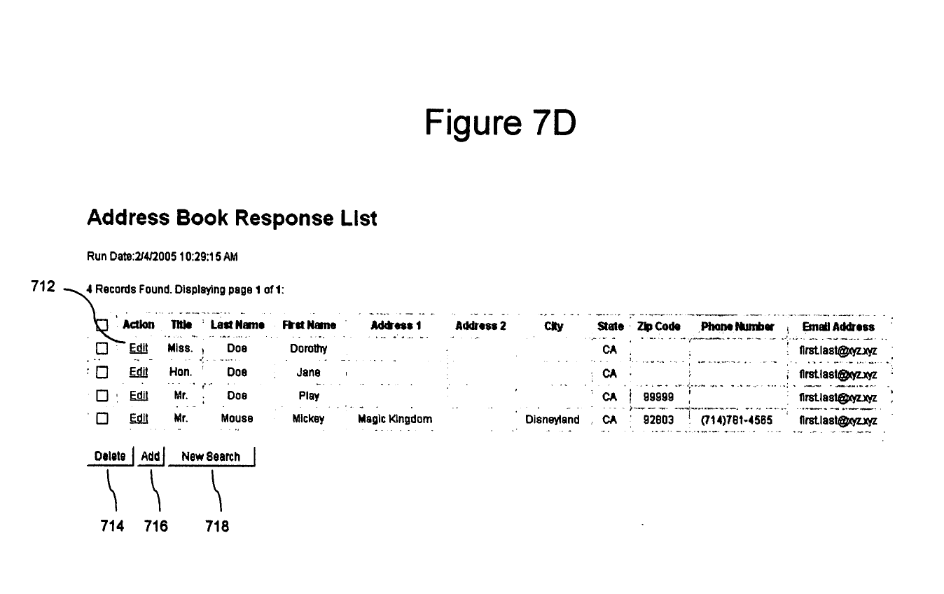

Turning to FIG. 7A, contents from an updated form management screen presented to a user in a preferred embodiment are shown. These contents are displayed to the user after depressing the “Submit” button 622 on the response entry screen. The contents are the same as those on FIG. 6A except that the responses field 702 and report field 704 have been updated to reflect the submission of a response by a user. In particular, responses field 702 has a “1” link allowing the user to view and edit (depending upon the users privileges) the one response that has been submitted. Report field 704 has a “Run” link allowing the user to generate (depending upon the user's privileges) reports based upon responses.

Turning to FIGS. 7B and 7C, contents from a response selection screen presented to a user in a preferred embodiment are shown. These contents are displayed to the user after activating the numbered link in Responses field 702 on the form management screen. The response selection screen allows the user to select responses for viewing and editing. For each question in the ODC form whose numbered link was activated, the response selection screen displays the question and a series of editable entities. The editable entities include a Show checkbox 706 allowing the user to select that question's responses for inclusion in or exclusion from viewed and editable responses. The editable entities also include Filter String field 708 allowing the user to filter particular responses submitted for a selected question. The Filter String field 708 may either be formatted as a pull-down menu or a free text box. The editable entities also include a Sort By pull-down menu 710 allowing the user to select how viewed and editable responses returned in the search are sorted. After the user has made selections, the user depresses “Search Response” button 711 to initiate a search that returns responses in accordance with the search criteria.

Turning to FIG. 7D, contents from a response viewing screen presented to a user in a preferred embodiment are shown. These contents are displayed to the user after depressing “Search Response” button 711 on the response selection screen. The response viewing screen allows the user to view and edit (depending on the user's privileges) the responses submitted to an ODC form and selected for viewing and editing in accordance with the user's search criteria. The screen shows the content of each selected response. The screen also includes an Action field 712 for each selected response having a selectable “Edit” link allowing the form owner to start the process of editing the response (if the user has editing privileges). If the user wishes to remove a response from the viewed responses, the user selects the checkbox left of the response to be removed from view and depresses the “Delete” button 714. If the user wishes to add a response, the select depresses the “Add” button 716 and is taken directly to the ODC form for data entry. Finally, if the user wishes to select other responses for viewing and editing, the user depresses the “New Search” button 718. Depression of “New Search” button 718 returns the user to the response selection screen.

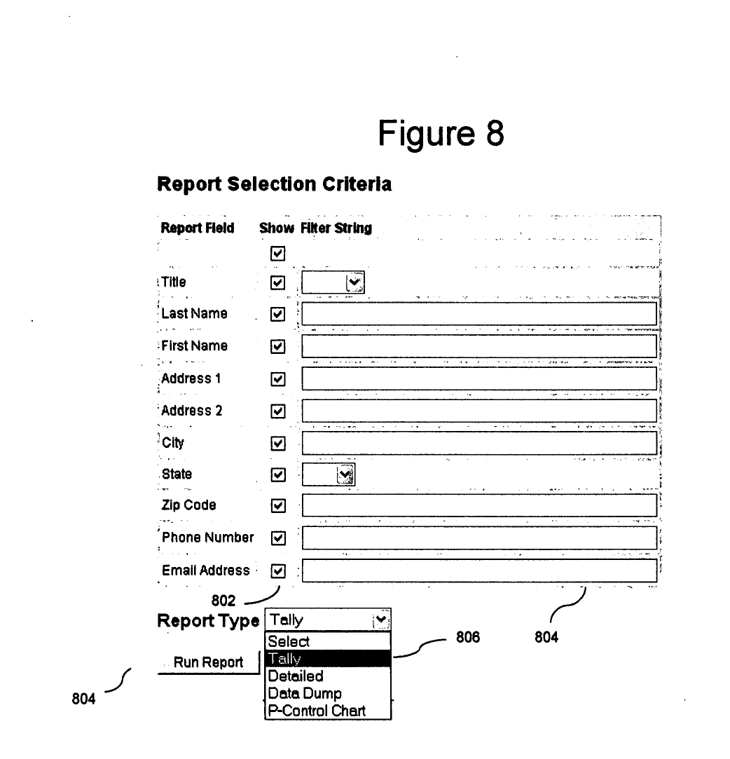

Turning to FIG. 8, contents from a report selection screen presented to a user in a preferred embodiment are shown. These contents are displayed to the user after activating the “Run” link in the Report field 704 of updated form management screen. The report selection screen allows the user to select responses for inclusion in reports. For each question in the ODC form whose link was activated, the response selection screen displays the question and a series of editable entities. The editable entities include a Show checkbox 802 allowing the user to select that question's responses for inclusion in or exclusion from the report. The editable entities also include Filter String field 804 allowing the user to filter particular responses submitted for a selected question. Filter string field 804 may either be formatted as a pull-down menu or a free text box. The editable entities also include a Report Type pull-down menu 806 allowing the user to select a type of report. Built-in report types include tally, detailed, data dump and P-Control chart. The tally report displays a percentage breakdown of all responses to each question. The detailed report displays all responses with the questions listed horizontally in the first row and each subsequent row as a response. The data dump report exports the responses into a CSV file. The P-Control chart report displays all responses within a P-Control chart. After the user has made selections, the user depresses “Run Report” button 804 to have generated a report in accordance with the report criteria.

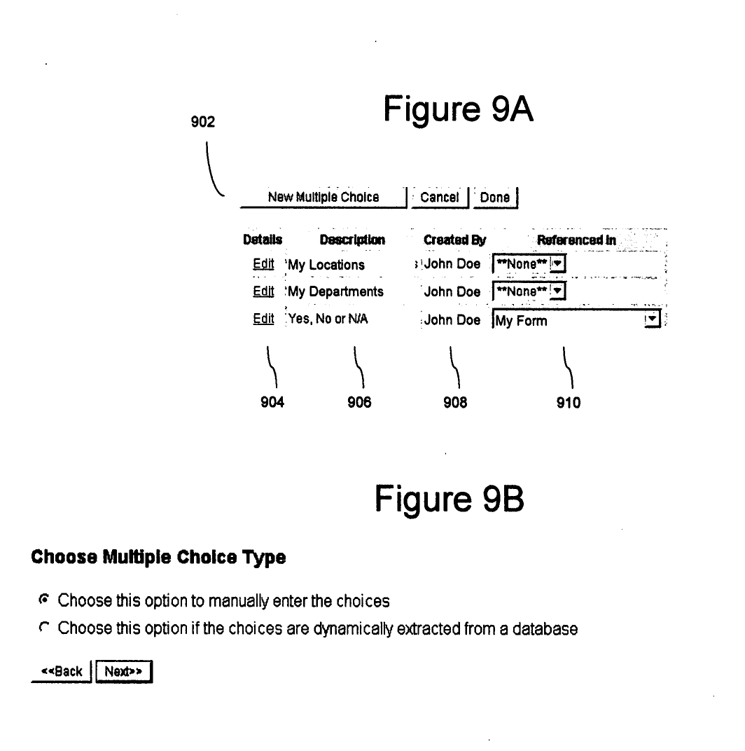

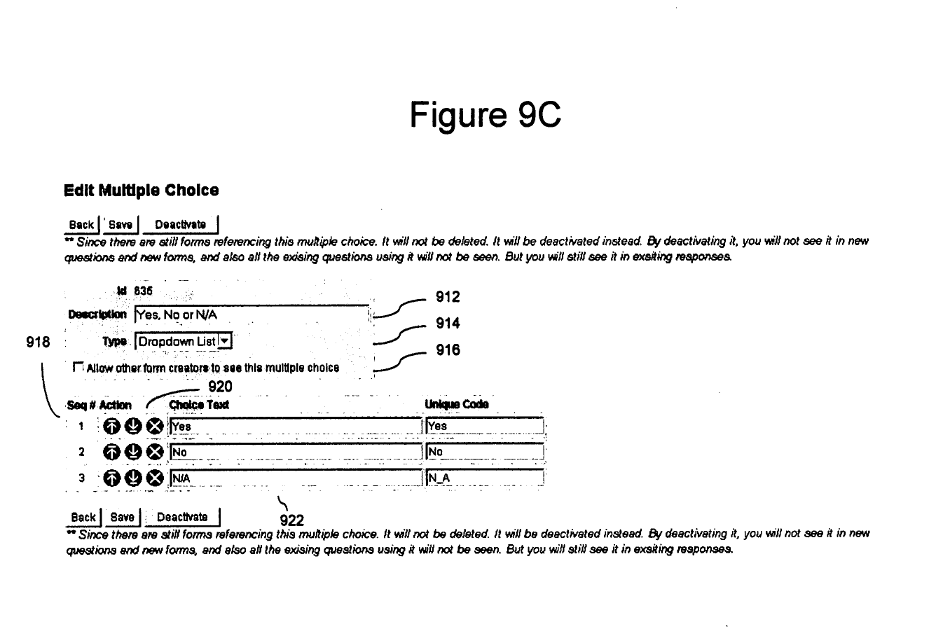

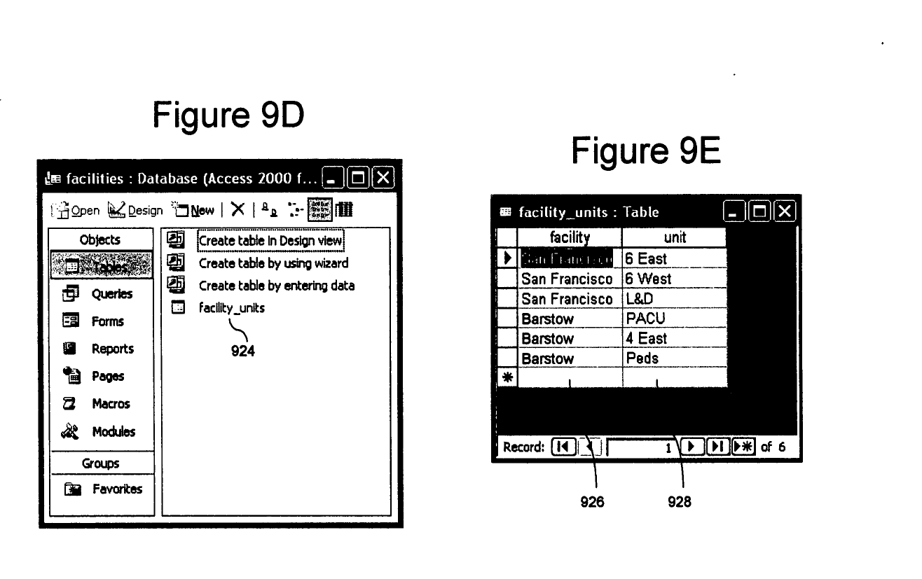

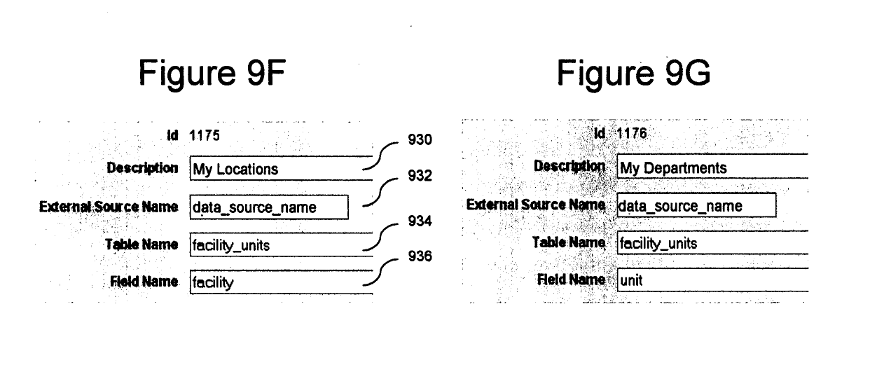

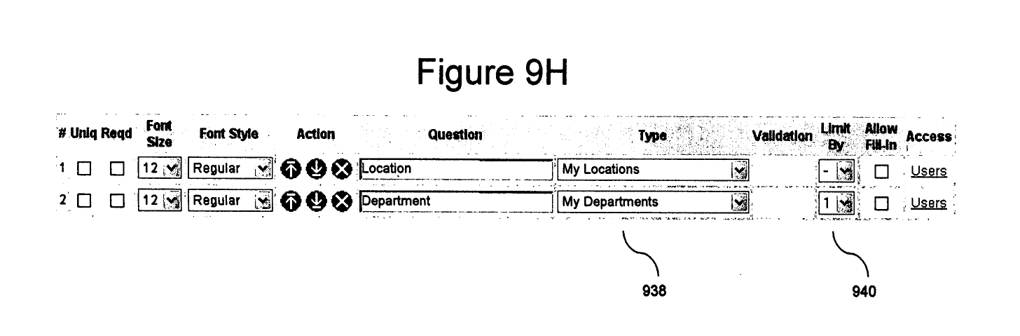

Turning to FIG. 9A, contents from a multiple choice management screen presented to a form owner in a preferred embodiment are shown. These contents are displayed to the form owner upon depressing “Multiple Choices” button 206 on the form management screen. The contents display current multiple choice questions that the form owner may import into one or more ODC forms and several selectable options. The form owner may start the process of creating a new multiple choice object by depressing “New Multiple Choice” button 902. Moreover, the form owner may manage the owner's current multiple choice objects. A multiple choice object includes a list of choices that can appear in a dropdown, list, radio button or checkbox. Once a multiple choice object is created, it can be linked to questions in a form. For example, a form owner can create a multiple choice object called “Colors” containing a list of color choices. When designing a form, the form owner can have two questions such as eye color and hair color, each linked to the multiple choice object called “Colors.” When the form is published, responses to the two questions must fall within the choices listed in the “Colors” multiple choice object. For each current multiple choice object, the contents include a series of descriptive fields, some of which have selectable links. The descriptive fields include a Details field 904 having a selectable “Edit” link allowing the form owner to start the process of editing the object; a Description field 906 displaying the title of the object; a Created By field 908 identifying the creator of the object; and a “Referenced in” field 910 having a pull-down menu identifying the ODC forms in which the object is currently being used. Identifying the ODC forms in which the object is currently being used informs the form owner what impact a change to the object would have.

Turning to FIG. 9B, contents from a multiple choice source selection screen presented to a form owner in a preferred embodiment are shown. These contents are displayed to the form owner after depressing “New Multiple Choice” button 902 on the multiple choice management screen. These contents present a multiple choice to the form owner regarding the source of choices for a new multiple choice object. The form owner selects the upper radio button if the choices are to be input manually by the form owner. The form owner selects the lower radio button if the choices are to be dynamically extracted from a database. The dynamic extraction option is powerful since the system can automatically import changes to the multiple choice object made in the database into all ODC forms where that object is currently being used, maintaining conformance between the ODC forms and the data in the database. Thus, a large number of ODC forms wherein the object is used can be updated dynamically through a single change made to the object in the database.

Turing to FIG. 9C, contents from a multiple choice manual editing screen presented to a form owner in a preferred embodiment are shown. These contents are displayed to the form owner after activating the “Edit” link in Details field 904 on the multiple choice management screen for a current multiple choice object, or successfully concludes the requisite steps to identify a new multiple choice object. In the example shown, activation of the “Edit” link in Details field 904 caused the screen to be displayed.

The multiple choice manual editing screen displays, as a series of editable entities, the profile of the multiple choice object whose “Edit” link was activated. The editable entities include Description field 912, which displays the title of the object. The editable entities also include Type field 914, which displays the format type of the object such as dropdown, list, radio button and checkbox. The editable entities also include multiple choice sharing checkbox 916, which indicates whether other form owners are allowed to view this multiple choice object. Additionally, for each current choice, the form editing screen includes a series of descriptive fields, some of which have editable fields and others which have selectable links, as well as action buttons. The descriptive fields include a Seq# field 918 indicating the sequence in which the choices will be displayed to users. The descriptive fields also include action buttons 920. Action buttons 920 include an up arrow button which, if depressed, will cause a new choice to be inserted immediately above the current choice, a down arrow button which, if depressed, will cause a new choice to be inserted immediately below the current choice, and an “X” button which, if depressed, will cause the current choice to be deleted. The descriptive fields also include a Choice Text field 922 which includes an editable text box displaying the current text of the choice.

Turning to FIG. 9D, an external software application window displaying a data file directory in a preferred embodiment is shown. In the illustrated example, the external software application is Microsoft Access, although other external software applications may be used. The directory identifies a “facility_units” data file 924 having choices appropriately formatted for importation, use and dynamic updating in an ODC form as a dependent multiple choice question.

Continuing the above example, and turning to FIG. 9E, an external software application window displaying the contents of the “facility_units” data file in tabular format in a preferred embodiment is shown. The table include two columns and six rows of data. The facility column 926 identifies two different facilities (San Francisco and Barstow). The unit column 928 identifies three different units within each facility.

Further continuing the above example, and turning to FIGS. 9F and 9G, the contents of multiple choice entry screens presented to a form owner in a preferred embodiment are shown. These contents are displayed to the form owner after the form owner successfully concludes the requisite steps to identify a multiple choice question whose choices are to be dynamically extracted from a database. The contents include a series of editable entities for the multiple choice question. Description text box 930 displays the title of the subject multiple choice question. External Source Name text box 932 displays the name of the external database from which choices are to be imported. Table Name text box 934 displays the name of the table from which choices are to be exported. Field name checkbox 936 displays the name of the column from which choices are to be exported. In the example shown, there are two multiple choice questions (My Locations and My Departments) for which choices are to be imported. The choices to be imported for both questions are stored in the same database (data_source_name) and in the same table (facility_units) of that database. However, the choices to be imported for the first question (My Locations) are found in a first column of that table (facility) whereas the choices to be imported for the second question (My Departments) are found in a second column of that table (unit).

Completing the above example, and turning to FIG. 9H, the contents of a dependent multiple choice question editing screen presented to a form owner in a preferred embodiment are shown. These contents are displayed to the form owner after activating the “Edit” link in details field 904 on multiple choice management screen for a current dependent multiple choice question. As seen, there is a first question (Location) and a second question (Department). The entries in the Type field 938 for the first question and the second question, respectively, specify “My Locations” and “My Departments,” indicating that the choices need to be imported from column “facility” and column “unit” within the external table (facility_units) in the external database (data_source_name). Moreover, Limit By field 940 in the second question further indicates that the choices for that question are conditioned upon the response to the first question. Thus, returning momentarily to FIG. 9E, when a user is presented with a response entry screen, if the user's response to the first question is “San Francisco,” the choices presented to the user for the second question will be limited to “6 East,” “6 West” and “L&D.” Conversely, if the user's response to the first question is “Barstow,” the choices presented to the user for the second question will be limited to “PACU,” “4 East” and “Peds.” Moreover, if the “facility_units” data file 924 is updated with modified choices, the modified choices will be dynamically imported into the ODC form and presented to subsequent users responding to the ODC form.

It will be appreciated by those of ordinary skill in the art that the invention can be embodied in other specific forms without departing from the spirit or essential character hereof. The present description is therefore considered in all respects illustrative and not restrictive. The scope of the invention is indicated by the appended claims, and all changes that come within the meaning and range of equivalents thereof are intended to be embraced therein.

I claim:

1. A method for observational data collection, comprising:
inputting into one or more configuration forms first information specifying content and format for an observational data collection form and one or more authorized users of the observational data collection form;
publishing to one or more of the authorized users at least a portion of the observational data collection form in conformance with the content and format; and
inputting by one or more of the authorized users into the at least portion of the observational data collection form, through a plurality of types of user terminals, second information in conformance with the content and format.

2. The method of claim 1, wherein the plurality of types of user terminals include at least one PC-type terminal and at least one PDA-type terminal.

3. A method for observational data collection, comprising:
inputting into one or more configuration forms first information specifying content and format for an observational data collection form and one or more authorized users of the observational data collection form;
publishing to one or more of the authorized users at least a first portion of the observational data collection form in conformance with the content and format;
inputting by one or more of the authorized users into the at least first portion of the observational data collection form second information in conformance with the content and format; and
publishing to one or more of the authorized users in response to at least a portion of the second information at least a second portion of the observational data collection form.

4. The method of claim 3, wherein the at least second portion of the observational data collection form comprises a dependent multiple choice question.

5. A method for observational data collection, comprising:
inputting into one or more configuration forms first information specifying content and format for an observational data collection form and one or more authorized users of the observational data collection form, wherein at least a portion of the first information is imported from a data file created using an external software system;
publishing to one or more of the authorized users at least a portion of the observational data collection form in conformance with the content and format; and
inputting by one or more of the authorized users into the at least portion of the observational data collection form second information in conformance with the content and format.

6. A method for observational data collection, comprising:
inputting into one or more configuration forms first information specifying content and format for an observational data collection form and one or more authorized users of the observational data collection form, wherein at least a portion of the content is automatically updated to conform with data in an external database;
publishing to one or more of the authorized users at least a portion of the observational data collection form in conformance with the content and format; and
inputting by one or more of the authorized users into the at least portion of the observational data collection form second information in conformance with the content and format.

7. The method of claim 6, wherein the first information specifies the portion of the content to be automatically updated to conform with the data in the external database.

8. A method for observational data collection, comprising:
inputting by a form owner into one or more configuration forms first information specifying content and format for an observational data collection form and one or more authorized users of the observational data collection form, wherein the authorized users are selected by the form owner from a group including at least one user dedicated to the form owner and at least one user shared by the form owner with other form owners;
publishing to one or more of the authorized users at least a portion of the observational data collection form in conformance with the content and format; and
inputting by one or more of the authorized users into the at least portion of the observational data collection form second information in conformance with the content and format.

9. The method of claim 1, wherein the first information further specifies one or more form access parameters for one or more of the authorized users.

10. The method of claim 1, wherein the first information further specifies one or more response access parameters for one or more of the authorized users.

11. The method of claim 1, wherein the first information further specifies one or more response format parameters for one or more of the authorized users.

12. The method of claim 1, wherein the first information further specifies one or more response time parameters for one or more of the authorized users.

13. The method of claim 1, further comprising inputting third information specifying one or more reporting parameters.

14. The method of claim 13, wherein the reporting parameters specify whether at least a portion of the second information will be exported into a data file executable by an external software system.

15. The method of claim 13, wherein the reporting parameters specify whether at least a portion of the second information will be exported from a system database to an external database.

16. A system for observational data collection, comprising a computer terminal for accepting as an input into one or more configuration forms first information specifying content and format for an observational data collection form and one or more authorized users and publishing at least a portion of the observational data collection form to a plurality of types of computer terminals associated with the one or more authorized users.

17. The system of claim 16, wherein the plurality of types of user terminals include at least one PC-type terminal and at least one PDA-type terminal.

18. The system of claim 16, wherein one or more of the authorized users inputs into the at least first portion of the observational data collection form second information in conformance with the content and format and wherein in response to at least a portion of the second information at least a second portion of the observational data collection form is published to one or more of the authorized users.

19. The system of claim 18, wherein the at least second portion of the observational data collection form comprises a dependent multiple choice question.

20. The system of claim 16, wherein at least a portion of the first information is imported from a data file created using an external software system.

21. The system of claim 16, wherein a portion of the content for the observational data collection form is automatically updated to conform with data in an external database.

22. The system of claim 16, wherein the one or more authorized users are selected by a form owner from a group including at least one user dedicated to the form owner and at least one user shared by the form owner with other form owners.

23. A computer program having instructions executable by a processor for accepting as an input into one or more configuration forms first information specifying content and format for an observational data collection form and one or more authorized users and for publishing at least a portion of the observational data collection form to one or more of the authorized users, wherein one or more of the authorized users inputs into the at least first portion of the observational data collection form second information in conformance with the content and format and wherein in response to at least a portion of the second information at least a second portion of the observational data collection form is published to one or more of the authorized users.

24. The program of claim 23, wherein the at least second portion of the observational data collection form comprises a dependent multiple choice question.

25. The program of claim 23, wherein at least a portion of the first information is imported from a data file created using an external software system.

26. The program of claim 23, wherein at least a portion of the first information is imported from an external database and is automatically updated in response to an update to data in the external database.
